(19) United States
(12) Patent Application Publication
(10) Pub. No.: US 2016/0304751 A1
(43) Pub. Date: Oct. 20, 2016

(54) ADHESIVE TAPE FOR COVERING ELONGATED GOODS, SUCH AS CABLE SETS IN PARTICULAR, AND METHOD FOR COVERING

(71) Applicant: TESA SE, Norderstedt (DE)

(72) Inventors: Bernhard MÜSSIG, Seevetal (DE); Ingo NEUBERT, Norderstedt (DE); Michael SIEBERT, Schenefeld (DE)

(73) Assignee: TESA SE, Norderstedt (DE)

(21) Appl. No.: 15/037,460

(22) PCT Filed: Nov. 17, 2014
(86) PCT No.: PCT/EP2014/074699

§ 371 Date: May 18, 2016

(30) Foreign Application Priority Data
Nov. 18, 2013 (DE) 10 2013 223 495.3

(51) Int. Cl. C09J 7/02; B32B 37/14; B32B 7/12; B32B 37/12

(52) U.S. Cl. CPC C09J 7/0285; B32B 37/12; B32B 37/14; B32B 7/12; C09J 2467/00; C09J 2433/00; B32B 2405/00

(57) ABSTRACT

Adhesive tape, in particular for wrapping elongated material such as cable harnesses in an automobile, comprising a carrier material that is provided at least on one side with an adhesive coating, characterized in that the carrier material comprises at least one layer containing at least 75 wt. % of polylactic acid (PLA), wherein the PLA contains a physical blend of at least two PLA polymers, i.e. at least one PLA polymer A and one PLA polymer B, wherein at least 80% of PLA polymer A is produced from 80% D,D-lactide and at least 80% of PLA polymer B is produced from 80% L,L-lactide, and wherein the ratio of D-lactic acid to L-lactic acid in the PLA blend is between 0.4:0.6 and 0.6:0.4.

The invention concerns an adhesive tape, preferably for wrapping elongated material such as wires or cable sets in particular. The invention also concerns use of the adhesive tape and an elongated material such as a cable set that is wrapped with the adhesive tape according to the invention.

In many areas of industry, bundles of multiple electrical wires are wrapped prior to installation or in premounted form in order to reduce the space requirement of the wiring bundle by bandaging and provide additional protective functions. The use of film adhesive tapes provides a certain degree of additional protection against penetration of liquids, the use of adhesive tape based on thick nonwovens or foams as carriers provides (mechanical and acoustic) damping properties, and the use of abrasion-resistant, stable carrier materials provides a protective function against rubbing and friction.

Adhesive tape for wrapping cables is tested and classified in the automobile industry according to comprehensive sets of standards such as LV 312-1, “Protection Systems for Cable Harnesses in Motor Vehicles, Adhesive Tapes; Test Guideline” (October 2009) as a common standard for the companies Daimler, Audi, BMW, and Volkswagen or the Ford Specification ES-AC3T-1A303-AA (Revision May 2011) ‘Harness Tape Performance Specification’. In the following, these standards are abbreviated as LV 312 or the Ford Specification respectively.

The noise damping, abrasion resistance, and temperature resistance of an adhesive tape are determined using specified test structures and test methods such as those described in detail in LV 312.

Adhesive tapes are then classified as shown below in Table 1:

TABLE 1
Noise damping class according to LV 312

| Noise damping class | Requirement | |
|---|---|---|
| A no noise damping | 0 to ≦2 | dB(A) |
| B slight noise damping | >2 to ≦5 | dB(A) |
| C moderate noise damping | >5 to ≦10 | dB(A) |
| D high noise damping | >10 to ≦15 | dB(A) |
| E very high noise damping | >15 | dB(A) |

The abrasion resistance of an adhesive tape is also determined according to LV 312 by means of a specified test method. Classification of the adhesive tape with respect to its abrasion resistance with a mandrel diameter of 5 mm is shown in Table 2:

TABLE 2
Abrasion resistance class according to LV 312

| Abrasion class | Requirement | |
|---|---|---|
| A no abrasion protection | <100 | strokes |
| B slight abrasion protection | 100-499 | strokes |
| C moderate abrasion protection | 500-999 | strokes |
| D high abrasion protection | 1,000-4,999 | strokes |
| E very high abrasion protection | 5,000-14,999 | strokes |
| F extremely high abrasion protection | ≧15,000 | strokes |

A test piece having a length of approx. 10 cm is applied longitudinally in one layer to a steel mandrel 5 mm in thickness. As an abrading tool, a steel wire with a diameter of 0.45 mm is scraped across the middle of the test piece under a weight load of 7 N. See LV 312 for further details. In contrast to LV 312, measurements are conducted only at room temperature.

Customized development of cable winding tapes for special requirements such as high temperature resistance is known.

A decisive property that must be fulfilled for the characterization and classification of adhesive tapes usable in particular for cable bandaging is temperature resistance (according to LV 312), which should preferably be B or higher.

To date, temperature classes A through E have been met as follows:
B (105° C.): uncrosslinked PE films; PP films; PP nonwovens, viscose
(125° C.): crosslinked PE films; polyester nonwovens in general, such as PBT, PA
D (150° C.): PET woven fabric

Storage is carried out for 3,000 h to determine maximum sustained-use temperature, 240 h for maximum short-term temperature, and 6 h for overload temperature.

| | Maximum | | Maximum | | | |
|---|---|---|---|---|---|---|
| Temperature | sustained-use | | short-term | | Overload | |
| class | temperature | | temperature | | temperature | |
| A | 85° | C. | 110° | C. | 135° | C. |
| B 100/105° C. | 100/105° | C. | 125/130° | C. | 150/150° | C. |
| C | 125° | C. | 150° | C. | 175° | C. |
| D | 150° | C. | 175° | C. | 200° | C. |
| E | 175° | C. | 200° | C. | 225° | C. |

In addition to the mechanical requirements to be met, other aspects are also playing an increasing role.

In light of ecological considerations and sustainability, and against the backdrop of the increasing scarcity of petroleum resources on the one hand and sharply increasing consumption worldwide of plastics on the other, efforts have been in progress for several years to produce plastics based on renewable raw materials and to promote the use thereof. This applies in particular to biodegradable polymers that are to be used in packaging applications or film applications. Biodegradable products are also playing an increasingly important role in medical applications. Several bio-based or biodegradable plastics are now commercially available.

Bio-based means produced from renewable raw materials.

“Biodegradable polymers” is a term for natural and synthetic polymers that show plastic-like properties (notched impact resistance, thermoplasticizability), but in contrast to conventional plastics, are degraded by numerous microorganisms in a biologically active environment (compost, sludge, soil, sewage); this does not necessarily occur under ordinary home conditions (composting in the garden). A definition of biodegradability can be found in the European standards DIN EN 13432 (Biodegradation of packaging) and DIN EN 14995 (Compostability of plastics).

Based on the fact that ecological aspects relating to biodegradability are also playing an increasingly important role for adhesive tape, adhesive tape using biodegradable films as a carrier material has also been presented. The films used are often based on polylactic acid compounds. Polylactic acid, like other biodegradable thermoplastic polymers suitable for this application, is relatively hard and brittle. In order to be suitable for film applications, the biodegradable polymers in question must be compounded with softer polymers, which are often non-biodegradable or only poorly biodegradable.

Polylactic acids or polylactides (abbreviated as PLA) are lactic acid-based polyesters that can be manufactured by ring-opening polymerization of lactide.

Polylactic acids are thermoplastics composed of lactic acid molecules. Lactides are of natural origin and can be produced by fermentation of molasses or glucose using various bacteria. As a polyhydroxycarboxylic acid, the polymer is completely compostable and biodegradable. Decomposition products are water and carbon dioxide. Thermal stability and mechanical properties can be modified over a wide range by compounding with other polymers such as polyolefins, with compostability and biodegradability decreasing as the content of non-compostable and non-biodegradable additives increases.

Polylactic acid is used as an absorbable surgical suture material and an encapsulation material for pharmaceuticals. Copolymers of L-lactic acid and ε-caprolactone are biodegradable orthopedic repair materials used for bone repairs, for example.

The production and use of polylactic acid films in the areas of packaging, agriculture, horticulture, and medical technology are sufficiently well-known.

Lactic acid is a chiral molecule, which means that it has the two forms of D- and L-lactic acid. L-lactic acid is preferably obtained by fermentation of starch/sugar using lactobacteria (for example, with a D-lactic acid content of only 0.5 to 2 wt. %). Dimerization mainly produces L,L-lactides that are used for polymerization. Poly-L-lactic acid (PLLA) is obtained. This PLLA is now used for the production of films and fibers/textiles. A considerable drawback of this use is the quite low thermal stability and hydrolysis resistance of PLLA.

PLLA-based carrier materials do not meet the known standards for temperature resistance of cable winding tapes such as the Ford Specification. In accelerated temperature storage according to T2, PLLA fails at only 130° C.

This gives rise to considerable drawbacks, for example in adhesive tape coating processes. PLLA films, for example, shrink at temperatures of only 80 to 120° C. (depending on the production process). PLLA nonwovens cannot be stably coated with hot melt adhesive compounds.

The use of PLA (in the form of a polyester) for a nonwoven fabric with a fiber mixture composed of synthetic fibers, cellulose fibers, and a binder is known from EP 1932892A1.

U.S. Pat. No. 5,658,646A and EP 0587069A1 describe an adhesive tape having a biodegradable carrier composed of aliphatic polyesters such as PLA.

DE 102005004789A1 discloses a biodegradable film with a base material from the group of polylactides, long-chain lactic acids, homo and copolyesters, and hydroxybutyrate and hydroxyvalerate polyesters that is filled up with organic and inorganic aggregates, preferably to a solid content of over 90 wt %.

In general, therefore, the polyester used can be any form of polyester. Examples include polyesters produced by ring-opening polymerization of lactones or polycondensation of hydroxycarboxylic acids.

The object of the present invention is to provide an adhesive tape that in particular is temperature resistant but also biodegradable and also allows simple, economical, and rapid wrapping of elongated material such as cable sets in automobiles.

This object is achieved by means of an adhesive tape, as set forth in the main claim. The object of the dependent claims is to provide advantageous improvements of the adhesive tape and methods for using the adhesive tape.

Accordingly, the invention concerns an adhesive tape, in particular for the wrapping of elongated material such as cable sets in an automobile, comprising a carrier material that is provided on at least on one side with an adhesive coating,

wherein
the carrier material comprises at least one layer containing at least 75 wt. % of polylactic acid (PLA), and preferably sc-PLA,
wherein the PLA contains a physical blend of at least two PLA-polymers, i.e. at least one PLA polymer A and one PLA polymer B,
wherein PLA polymer A comprises at least 80% D,D-lactide and PLA polymer B is comprises at least 80% L,L-lactide, and
wherein the ratio of D-lactic acid to L-lactic acid in the PLA blend is 0.4:0.6 to 0.6:0.4.

The indication that the carrier material comprises at least one layer containing at least 75 wt. % of polylactic acid (PLA) means that the layer-forming polymer contains 75 wt. % of polylactic acid (PLA) and up to 25 wt. % of other polymers.

In addition to the polymers, the layer can also contain additives such as fillers, pigments, anti-aging agents, nucleating agents, antioxidants, impact modifiers, or lubricants.

The total amount thereof should preferably not exceed one in 100 parts of the polymers.

By means of biotechnological manipulation (white biotechnology), microorganisms can be cultured that chiefly produce D-lactic acid. The PDLA polymer produced by this method (PLA of D,D-lactide) shows properties identical to those of PLLA.

PDLA is commercially available as Puralact® from Purac.

These enantiomers of pure lactic acid monomers are dimerized to form lactides (Purac brand names: Puralact L=LL-lactide; Puralact D=DD-lactide). These enantiomers of pure lactides are then polymerized by the company Synbra into commercially available PLA (PDLA (type Synterra PLA 100D; L content<1 wt. %) and PLLA (Type Synterra PLA 1510; D content<1 wt. %)) polymers.

By racemic crystallization of stereochemically pure PDLA and PLLA in equal parts, one obtains the so-called stereocomplex (sc-PLA).

This sc-PLA shows sharply higher thermal stability. The melting point of the sc-PLA increases from 170 to 180° C. (PLLA) to 210 to 220° C. (sc-PLA). sc-PLA has a higher degree of crystallinity than PLA. sc-PLA is also characterized by sharply higher crystallization rate (by a factor of 3 or 4), thus increasing the strength of fibers produced from sc-PLA. Moreover, sharply higher hydrolysis resistance is observed. In a result that is surprising and unforeseeable for the person skilled in the art, this makes it possible to provide carriers for adhesive tapes that can be exposed during the production process to higher temperatures than those occurring for example in hotmelt coating with an adhesive, and these temperatures in particular meet the specifications of the required temperature standards and can be used in moisture-sensitive areas. In order to produce sc-PLA fibers for textile carriers such as woven fabric, PDLA and PLLA are fused in an extruder at a 1:1 ratio, homogenously blended (at temperatures above the melting point of sc-PLA of 220° C.) and woven into fibers.

According to an advantageous embodiment of the invention, the carrier material comprises at least 80 wt. %, preferably at least 90 wt. %, and more preferably at least 95 wt. % of sc-polylactic acid (sc-PLA).

Alternatively, it is preferable for the carrier to consist of 100 wt. % of sc-polylactic acid (sc-PLA).

More preferably, the PLA polymer A forming the PLA blend comprises at least 90%, and preferably at least 95% of D-lactic acid and/or the PLA polymer B forming the PLA comprises at least 90%, and preferably at least 95%, of L-lactic acid.

More preferably, the ratio of D,D-lactide to L,L-lactide in the polylactic acid is 0.45:0.55 to 0.55:0.45, particularly preferably 0.48:0.52 to 0.52:0.48, and most particularly preferably 0.5:0.5.

In the simplest and preferred embodiment, the carrier material comprises exactly one layer containing at least 75 wt. % of polylactic acid (PLA).

In general, all carrier materials are suitable for use as carriers, with textile carriers being preferred and woven and nonwoven fabrics being particularly preferred.

All known textile carriers, such as knit fabrics, non-crimp fabrics, tapes, meshes, tufted fabrics, felts, woven fabrics (comprising linen, twill, and satin weaves), knit fabrics (comprising warp-knit fabrics and knitwear), or nonwovens can be used, wherein the term “web” is to be understood as referring at least to textile fabrics according to EN 29092 (1988) and stitchbonded nonwovens and similar systems.

According to the invention, the carrier is preferably a textile carrier, preferably a woven, nonwoven, or knit fabric, and the carrier should have a basis weight of 30 to 250 g/m², preferably 50 to 200 g/m², and particularly preferably 60 to 150 g/m².

Woven and knit spacer fabrics with lamination can also be used. Such spacer fabrics are disclosed in EP 0071212B1. Spacer fabrics are mat-like layered structures with a covering layer of a fiber or filament web, an underlayer, and individual or bundled retaining fibers between these layers that are distributed over the area of the layered structure in such a way that they are needle-punched through the particle layer, bonding the covering layer and the underlayer to each other. As an additional but not required feature, according to EP 0071212B1, these retaining fibers contain inert stone particles such as sand, gravel, or the like.

The retaining fibers needle-punched through the particle layer maintain the covering layer and the underlayer at a distance from each other, and they are bonded to the covering layer and the underlayer.

Consolidated staple fiber webs, but also filament, meltblown, and spunbonded webs, which usually require additional consolidation, are particularly suitable as nonwovens. Examples of known consolidation methods for webs are mechanical, thermal, and chemical consolidation. While in the case of mechanical consolidation, the fibers are usually held together purely mechanically by entanglement of the individual fibers, intermeshing of fiber bundles, or stitchbonding of additional threads, both thermal and chemical methods make it possible to obtain adhesive (containing binders) or cohesive (binder-free) fiber-fiber bonds. By means of proper formulation and process control, these can be exclusively or at least predominantly restricted to fiber nodal points, so that in obtaining the loose, open structure of the nonwoven fabric, a stable three-dimensional network is nevertheless formed.

Nonwovens consolidated by overstitching with separate threads or by intermeshing in particular have been found to be particularly advantageous. For example, such consolidated nonwovens are produced on stitchbonding machines of the “Malimo” type from the company Karl Mayer, formerly Malimo, and are available from companies such as Techtex GmbH. A Maliweb is characterized in that a longitudinal fiber web is consolidated by the formation of loops from fibers of the web.

A nonwoven fabric of the Kunit or Multiknit type can also be used as a carrier. A Kunit web is characterized by originating from the processing of a longitudinally-oriented fiber web into a textile fabric having loops on one side and loop feeds or pile fiber folds on the other, but contains neither threads nor prefabricated textile fabrics. For example, this type of nonwoven fabric has been produced for some time on stitchbonding machines of the “Malimo” type from the company Karl Mayer. Another characteristic feature of this web is that as a longitudinal fiber web, it can absorb high tensile forces in the longitudinal direction. In contrast to the Kunit web, a Multiknit web is characterized in that the nonwoven fabric is consolidated on both the top and bottom sides by means of double-sided needle punching. As a rule, one or two single-sided intermeshed pile fiber-web active ingredients produced by the Kunit method serve as starting product(s) for a Multiknit. In the final product, both web material upper sides are formed into a closed surface by fiber intermeshing and bonded to each other by means of fibers in a virtually perpendicular orientation. It is also possible to incorporate additional penetrable textile fabrics and/or scatterable media.

Finally, stitchbonded webs are also suitable as starting products for producing carriers and an adhesive tape according to the invention. A stitchbonded web is composed of a nonwoven fabric having a plurality of stitches oriented parallel to one another and is known as Maliwatt. These stitches originate from stitching-in or stitchbonding of continuous textile threads. Stitchbonding machines of the “Malimo” type from Karl Mayer are also known for this type of nonwoven fabric.

Needle-punched webs are also particularly suitable. In needle-punched webs, a tuft of fibers is made into a fabric by means of needles provided with barbs. The material is consolidated on a needle bar by alternately inserting and withdrawing the needles, causing the individual fibers to be looped into a solid fabric. The number and configuration of the needle punching points (needle shape, penetration depth, double-sided needle punching) determine the thickness and strength of the fabrics, which are generally light, air-permeable, and elastic.

Advantageously, and at least in areas, the surface of the carrier should be polished smooth on one or both sides, and preferably has a surface smoothly polished over the entire area in each case. The smoothly polished surface can be chintzed, as explained in EP 1448744A1, for example. Dirt-repelling properties are improved in this manner.

A carrier composed of paper, a laminate, a film, foam, or a foamed film is also suitable for wrapping the elongated film.

Preferably, the laminate is composed of a textile carrier in the form of a staple fiber web or a spunbonded web and a film on the underside of the textile carrier, with said film having a thickness of 15 to 80 μm.

Non-textile sheet materials are particularly suitable in cases where special requirements require the invention to be modified in this manner. Compared to textiles, for example, films are thinner, and because of said closed layer, additional protection against penetration by agents such as oil, gasoline, antifreeze and the like into the actual cable area is provided.

In contrast, however, foams or foamed films have the property of greater space filling and favorable noise damping—if a cable is laid in a ductlike or tunnel-like area of a vehicle, for example, wrapping tape having suitable thickness and noise damping can prevent from the outset disruptive flapping and vibrating.

According to the invention, the layer composed essentially of PLA (or the carrier in the preferred embodiment of the single-layer carrier) can contain other materials in addition to PLA.

Blended webs can be produced particularly easily by adding other fibers. Examples of suitable fiber blends for this purpose include PET, PPLA, and sc-PLA. This blending makes it possible to reduce material costs so that, together with an adhesive, the respective higher-resistance polyester type ensures bonding of the adhesive tape during use.

The inventive concept also includes a blend of sc-PLA with PLLA that can be used as a “melt fiber” because it has a lower melting point. This allows tearing out of fibers during unrolling of the tape to be sharply reduced. In particular, (biodegradable) aliphatic copolyesters can be used as melt fibers.

Specifically, preferred starting materials for the carrier that are not composed of PLA include (chemical) fibers (staple fibers or endless filament) comprising synthetic polymers, also referred to as synthetic fibers composed of polyester, polyamide, polyimide, aramid, polyolefin, polyacrylonitrile, or glass, (chemical) fibers comprising natural polymers such as cellulose fibers (viscose, Modal, Lyocell, Cupro, acetate, triacetate, Cellulon), rubber fibers such as vegetable protein fibers and/or animal protein fibers and/or natural fibers of cotton, sisal, flax, silk, hemp, linen, coconut, or wool. However, the present invention is not limited to the above-mentioned materials, and a number of other fibers known to the person skilled in the art without requiring an inventive step can be used. Moreover, yarns produced from the above-mentioned fiber materials are also suitable.

For woven fabrics or non-crimp fabrics, individual threads composed of a mixed yarn can be produced, i.e. having synthetic and natural components. In general, however, the weft threads and warp threads respectively are formed separately according to type.

In this case, the weft threads and/or warp threads respectively can consist exclusively of synthetic threads or threads composed of natural raw materials.

All known adhesive systems can be used to produce an adhesive tape from the carrier material. In addition to natural or synthetic rubber-based adhesives, silicone adhesives in particular, as well as polyacrylate adhesives, preferably an acrylate hotmelt adhesive, can be used. Because of their particular suitability as adhesives for tapes of automotive cable sets with respect to prevention of fogging and their outstanding compatibility with PVC and PVC-free core insulation, solvent-free acrylate hotmelt adhesives such as those described in further detail in DE 19807752A1 and DE 10011788A1 are preferred.

The coating weight preferably varies in the range of 15 to 200 um, more preferably 30 to 120 g/m² (corresponding approximately to a thickness of 15 to 200 μm, and more preferably 30 to 120 μm).

The adhesive is preferably a pressure-sensitive adhesive, i.e. an adhesive that allows lasting bonding to almost all adhesive substrates with only slight applied pressure and can be redetached from the adhesive substrate after use, leaving virtually no residue. At room temperature, pressure-sensitive adhesives show permanent pressure-sensitive adhesion, i.e. they have sufficiently low viscosity and sufficiently high initial tack so that the respective adhesive surface is moistened with only slight pressure. The bondability of the adhesive is based on its adhesive properties, and its redetachability is based on its cohesive properties.

A suitable adhesive is based on acrylate hotmelt and has a K value of at least 20, in particular greater than 30 (measured respectively in a 1 wt % toluene solution at 25° C.), and is obtainable by concentration of a solution of said adhesive into a system that is processable as a hotmelt.

The K value (according to Fikentscher) is a measure of the average molecule size of high-polymer compounds. Viscosity of polymers is determined using a capillary viscometer according to DIN EN ISO 1628-1:2009.

For measurement, 1% (1 g/100 mL) toluene polymer solutions are prepared at 25° C. and measured using the corresponding DIN Ubbelohde viscosimeter according to ISO 3105:1994, Table B.9.

Concentrating can be carried out in suitably equipped vessels or extruders, and in the case of accompanying degassing in particular, a degassing extruder is preferred.

An adhesive of this type is presented in DE 4313008C2. The solvent is completely removed from the acrylate adhesives produced in this manner in an intermediate step.

In addition, further volatile components are removed by this method. After coating from the melt, these adhesives show only small percentages of volatile components. All of the monomers/formulas claimed in the patent cited above can therefore be used.

The adhesive solution can contain 5% to 80 wt % of solvent, and preferably 30% to 70 wt %.

Commercial solvents are preferably used, in particular low-boiling-point hydrocarbons, ketones, alcohols and/or esters.

More preferably, single-screw, twin-screw, or multiple-screw extruders having one or preferably two or more degassing units are used.

Benzoin derivatives such as benzoin acrylate or benzoin methacrylate and acrylic acid or methacrylic acid esters can be incorporated by polymerization into the acrylate hotmelt-based adhesive. Such benzoin derivatives are described in EP 0578151A.

The acrylate hotmelt-based adhesive can be UV crosslinked. However, other types of crosslinking are also possible, such as electron beam crosslinking.

In a further preferred embodiment, copolymers of (meth)acrylic acid and esters thereof with 1 to 25 carbon atoms, maleic, fumaric and/or itaconic acid and/or esters thereof, substituted (meth)acrylamides, maleic anhydride, and other vinyl compounds such as vinyl esters, in particular vinyl acetate, vinyl alcohols, and/or vinyl ethers, are used as self-adhesives.

The residual solvent content should be less than 1 wt. %.

An adhesive found to be particularly suitable is a pressure-sensitive acrylate hotmelt adhesive such as that available under the name acResin, in particular acResin A260, from BASF. This adhesive having a low K value takes on its adhesive properties in accordance with the application on final crosslinking using radiation-chemical methods.

Other outstandingly suitable adhesives are described in the documents DE 102011075152A1, DE 102011075156A1, DE 102011075159A1, and DE 102011075160A1.

The adhesive is preferably applied over the entire surface of the carrier.

The adhesive can be applied in the longitudinal direction of the adhesive tape in the form of a strip that is narrower than the carrier material of the adhesive tape.

In an advantageous embodiment, the coated strip has a width that is 10 to 80% that of the carrier material. Particularly preferably, the width of the coated strip is 20 to 50% that of the carrier material.

Depending on the application, a plurality of parallel strips of the adhesive can be applied to the carrier material.

The position of the strip on the carrier is freely selectable, with a configuration directly at one of the edges of the carrier being preferred.

Moreover, two adhesive strips can be provided, specifically an adhesive strip on the upper side of the carrier material and an adhesive strip on the underside of the carrier material, wherein the two adhesive strips are preferably configured on the opposing longitudinal edges. According to a variant, the two adhesive strips are configured on the same longitudinal edge.

Preferably, the adhesive strip(s) is/are flush with the longitudinal edge(s) of the carrier material.

At least one strip of a liner can be provided on the adhesive coating of the carrier that run(s) in the longitudinal direction of the adhesive tape and cover(s) 20% to 90% of the adhesive coating.

The strip preferably covers a total of 50% to 80% of the adhesive coating. The degree of coverage is selected based on the application and the diameter of the cable set.

The percentages given refer to the width of the strips of the liner with respect to the width of the carrier.

According to a preferred embodiment of the invention, exactly one strip of the liner is present on the adhesive coating.

The position of the strip on the adhesive coating is freely selectable, with configuration directly at one of the longitudinal edges of the backing being preferred. In this manner, an adhesive strip is produced which extends in the longitudinal direction of the adhesive tape and stops at the other longitudinal edge of the carrier.

If the adhesive tape is used for wrapping a cable set by winding the adhesive tape in a spiral motion around the cable set, wrapping of the cable set can be carried out in such a way that the adhesive of the adhesive tape is glued only to the adhesive tape itself, while the material does not come into contact with any adhesive.

Because the cable is not fixed in place by any adhesive, the cable set wrapped in this manner shows extremely high flexibility. This sharply increases its bendability on installation—particularly in the case of narrow passages or sharp bends.

In cases where a certain degree of fixation of the adhesive tape on the material is desired, wrapping can be carried out in such a way that the adhesive strip adheres partially to the adhesive tape itself and partially to a different area of the material.

According to another advantageous embodiment, the strip is applied to the middle of the adhesive coating, thus producing two adhesive strips extending at the longitudinal edges of the carrier in the longitudinal direction of the adhesive tape.

Two adhesive strips at the longitudinal edges of the adhesive tape respectively are advantageous for securely and economically applying the adhesive tape by means of the above-mentioned spiral motion around the cable set and for preventing slippage of the resulting protective wrapping, particularly if the first of the strips, which is usually narrower than the second strip, serves as a fixation aid and the other, wider strip serves as a seal. In this manner, the adhesive tape adheres to the cable in such a way that the cable set is secured against slippage but remains flexibly configured.

There are also embodiments in which more than one strip is applied to cover the adhesive coating. If only one strip is referred to, the person skilled in the art will read this as meaning that a plurality of strips can certainly also be applied simultaneously to cover the adhesive coating.

Production and processing of the adhesive can be carried out from solution, from dispersion, or from the melt. Production and processing are preferably carried out from solution or the melt. Particularly preferably, the adhesive compound is produced from the melt, and batch or continuous methods in particular can be used. Particularly preferred is continuous production of pressure-sensitive adhesives using an extruder.

The adhesives produced in this manner can then be applied to the carrier by means of generally known methods. In processing from the melt, this application can take place through a nozzle or a calender.

In production from solution, the coating can be carried out using scrapers, blades, or nozzles, to name only a few possibilities.

It is also possible to transfer the adhesive from an anti-adhesive carrier fabric or release liner to the carrier assembly.

Finally, the adhesive tape can have a covering material with which the one or two adhesive layer(s) are covered until use. All of the materials set forth in detail above are suitable as covering materials. Preferably, however, a non-linting material should be used, such as a plastic film or a well-glued long-fiber paper.

A back side lacquer may be applied to the back side of the adhesive tape in order to favorably influence the unrolling properties of the adhesive tape wound into an Archimedean spiral. For this purpose, this back side lacquer can be provided with silicone or fluorosilicone compounds as well as polyvinylstearyl carbamate, polyethyleneimine stearyl carbamide, or organofluorine compounds as adhesively-acting substances. Optionally, a foam coating is configured under the back side lacquer or on the back side of the adhesive tape.

The adhesive tape according to the invention can be supplied in fixed lengths, e.g. by the meter, or, however, as a continuous product on rolls (Archimedean spirals). In the latter case, for application, the tape may be cut to variable lengths using knives, scissors, or dispensers, etc., or manually processed without using tools.

The adhesive tape can also have one or a plurality of weakened lines that are essentially at right angles to the running direction, making the adhesive tape easier to tear by hand. In order to allow the user to work in a particularly simple manner, the weakened lines are oriented at right angles to the running direction of the adhesive tape and/or are configured at regular intervals.

It is particularly easy to cut through the adhesive tape if the weakening lines are configured in the form of perforations.

In this manner, edges can be achieved between the individual sections that have an extremely low lint content, thus preventing undesired fraying.

In a particularly advantageous process, the weakened lines can be produced discontinuously using flatbed dies or transverse perforation wheels or continuously using rotary systems such as spiked rollers or punching rollers, and optionally a counter-roller (vulkollan roller), with these being used as the counterwheel in cutting.

Further possibilities include controlled cutting technologies with intermittent operation, such as the use of lasers, ultrasound, or high-pressure water jets, etc. If a portion of the energy is transferred as heat to the carrier material, as is the case in laser or ultrasound cutting, the fibers can be fused in the cutting area in order to prevent fraying to the extent possible and obtain sharp cutting edges. The latter methods are also suitable for achieving particular cutting edge geometries, such as cutting edges formed in a concave or convex shape.

The height of the spikes or blades on the punching rollers should preferably be 150% of the thickness of the adhesive tape.

The cut-to-tie ratio in perforation, i.e. the ratio of the length in mm of the parts separating the material to that of the parts holding the material together (“bridges”), determines in particular how easy it is to tear the fibers of the carrier material. Finally, said ratio also affects the extent to which the torn edge is free of lint.

The width of the ties should preferably be approximately 2 mm, and the width of the cuts between the ties should be approximately 10 mm, i.e., ties 2 mm in width alternate with cuts 10 mm in width. Accordingly, the cut-to-tie ratio is preferably 2:10.

This weakening of the material makes it possible to achieve a sufficiently low tearing force.

If one wishes to achieve low flammability of the adhesive tape described, this can be achieved by adding flame retardants to the carrier and/or the adhesive. These can be organobromine compounds, if necessary together with synergists such as antimony trioxide, but in order to obtain a halogen-free adhesive tape, red phosphorus or organophosphorus compounds, mineral compounds, or intumescent compounds such as ammonium polyphosphate should preferably be used, alone or together with synergists.

According to a preferred embodiment, the width of the adhesive tape is between 9 and 38 mm.

The general term “adhesive tape” in the context of this invention comprises all sheetlike materials, such as films extended in two dimensions or film sections, tapes of extended length and limited width, tape sections, and the like, and finally blanks or labels as well.

Moreover, it is advantageous for wrapping elongated materials such as cable sets in motor vehicles in particular if the adhesive tape is wound around the elongated material in a spiral or if the elongated material can be wrapped with the band in an axial direction. Finally, the concept of the invention also includes an elongated material wrapped with an adhesive tape of the invention. The elongated material should preferably be a cable set.

Because of the outstanding suitability of the adhesive tape, in can be used in a wrapping comprising a liner in which the self-adhesively provided adhesive tape is present at at least one edge area of the liner, adhering in such a manner that the adhesive tape extends over one of the longitudinal edges of the liner, and preferably in an edge area narrower than the width of the liner.

This type of product, as well as optimized embodiments thereof, are disclosed in EP 1312097A1. EP 1300452A2, DE 10229527A1, and WO 2006108871A1 present enhancements for which the adhesive tape according to the invention is also highly suitable. The adhesive tape according to the invention can also be used in a method such as that disclosed in EP 1367608A2.

Finally, EP 1315781A1 and DE 10329994A1 disclose embodiments of adhesive tape that are also possible for the adhesive tape according to the invention.

Finally, the concept of the invention also includes elongated material wrapped with an adhesive tape according to the invention. This elongated material is preferably a cable set, and more preferably a cable set used in an automobile.

The adhesive tape according to the invention provides advantages that would not have been foreseeable by a person skilled in the art.

First, the stability of the carrier composed of sc-PLA at high temperature is to be mentioned. A standard PLA is thermally unstable, tends to shrink, and cannot be coated with solvent-based adhesives or hot-melt adhesives.

Moreover, the carrier according to the invention and the adhesive tape produced with this carrier meet the technical requirements for adhesive tape, particularly cable wrapping tape, even though the carrier is (predominantly) biobased.

In the following, the adhesive tape will be explained in further detail with reference to several figures and examples, which are not to be understood as limiting the invention in any manner.

The figures show the following:

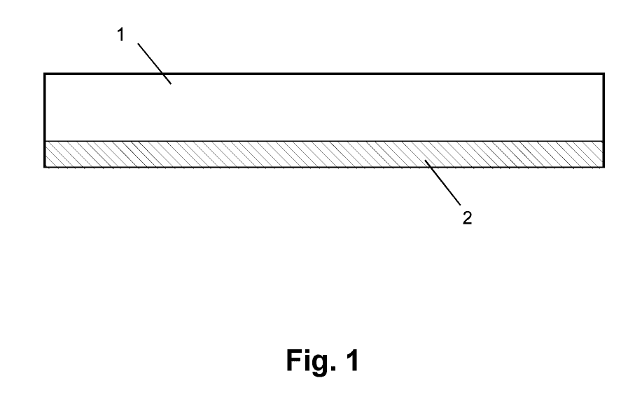

FIG. 1: the adhesive tape in a lateral section,

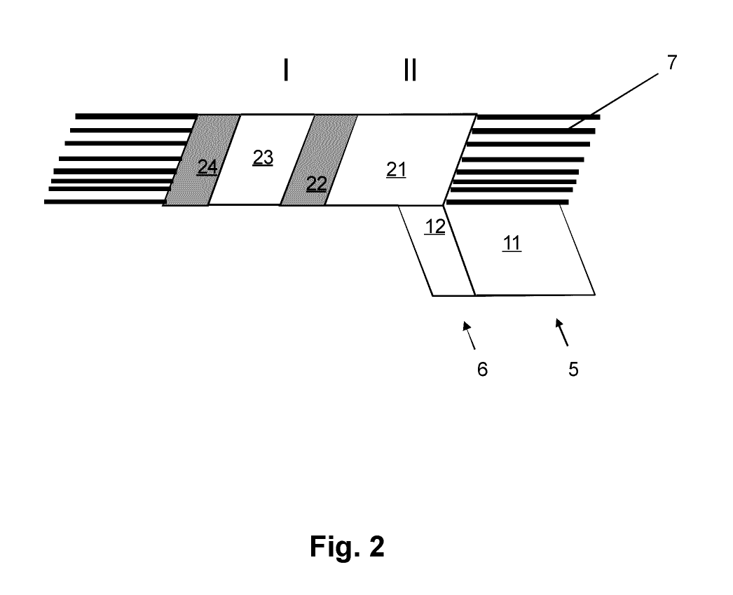

FIG. 2: a detail of a cable set composed of a bundle of individual cables and wrapped with the adhesive tape according to the invention, and

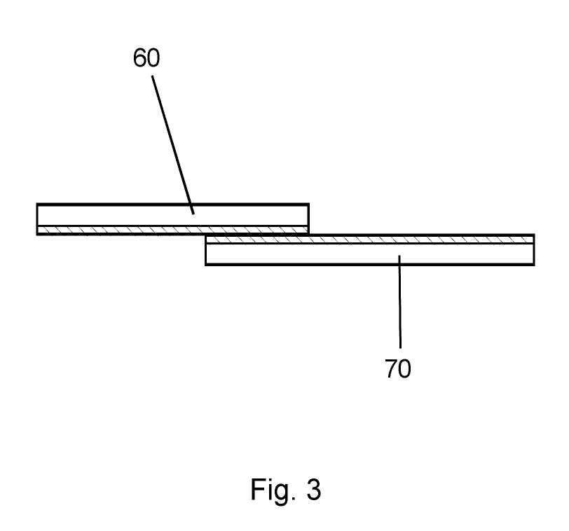

FIG. 3: an advantageous application of the adhesive tape.

The adhesive tape shown in a lateral section (cross-section) in FIG. 1 comprises a carrier material 1 to one side of which a layer of a seal-adhesive coating 2 is applied.

The carrier material 1 comprises a nonwoven fabric of 100% PLA.

As described in EP 1081202A1, the adhesive 2 permeates into the textile carrier 1 (for example, by 10 μm to 0.5 mm), thus ensuring that the adhesive is anchored.

FIG. 2 shows a section of a cable set composed of a bundle of individual cables 7 and wrapped with the adhesive tape according to the invention. The adhesive tape is wrapped around the cable set in a spiral motion.

The section of the cable set in the figure shows two turns I and II of the adhesive tape. Further wrapping would extend to the left, but this is not shown in the figure.

A strip 5 of the liner is present on the adhesive coating, thus constituting an adhesive strip 6 extending in the longitudinal direction of the tape. The adhesive tape has alternating nonadhesive areas 11, 21, and 23 and adhesive areas 12, 22, and 24. (In contrast to the exposed adhesive 12, sections 22, 24 are not visible from the outside, and denser shading has therefore been used to represent them.)

The cable set is wrapped in such a manner that the adhesive strip 6 adheres completely to the adhesive tape. This prevents adhesion to the cables 7.

In a further embodiment of a wrapping, two tapes according to the invention provided with an adhesive 60, 70 are laminated to each other with their adhesive surfaces offset (preferably by 50% respectively), resulting in the product shown in FIG. 3.

The adhesive tapes with carriers according to the invention can be relatively easily torn by hand, which is also of particular significance for the purpose of the application described and the particularly preferred configuration of tape for wrapping cable bundles in automobiles.

Tear strength in the longitudinal direction of less than 10 N, which is specified according to AFERA Standard 4007, serves as a criterion for hand tearability of the adhesive tape.

In the following, the invention will be explained in greater detail by means of examples, but these are by no means to be interpreted as limiting the scope of the invention in any manner.

Measurements are conducted according to the following standards:
Basis weight of woven fabric and adhesive coating according to DIN EN ISO 2286-1
Yarn weight according to DIN 53830 Part 3
Thread count according to DIN EN 1049 Part 2
Adhesive strength according to DIN EN 1939
Thickness of woven fabric and adhesive tapes according to DIN EN 1942

In the following, a woven fabric and a nonwoven fabric are tested in further detail. The fibers used for forming the woven fabric or the web are composed of 50 wt. % of PDLA of the Synterra PLA 100D type and 50 wt. % of PLLA of the Synterra PLA 1510 type, i.e. (almost) pure sc-PLA.

The polymer mixture is fused in an extruder and processed into fibers via spinnerets. These fibers are further processed into woven or nonwoven fabrics by methods known to the person skilled in the art.

The risk or expense of adapting these production steps compared to those of PET is low, as the sc-PLA has melting temperatures of approx. 210 to 220° C., sharply higher than those of PLA of 170 to 180° C.

Finally, coating is carried out using an acrylate pressure-sensitive adhesive (acResin A 260 UV from BASF).

In this method, in contrast to PLLA-based carriers, temperatures higher than 80 to 120° C. can be used without damage to the carriers, for example by shrinkage.

### Example 1

Fabric Construction

TABLE 1
Fabric construction

| | (I) | |
|---|---|---|
| Carrier material | PLA fabric | |
| Basis weight | 130 | g/m² |
| Thread count, longitudinal (warp) | 48/cm | |
| Thread weight, longitudinal | 167 | dtex |
| Thread count, transverse (weft) | 23/cm | |
| Thread weight, transverse | 167 | dtex |

| | |
|---|---|
| Temperature stability | D |

TABLE 2
Adhesive tape properties

| | (I) | |
|---|---|---|
| Adhesive type | acrylate | |
| Adhesive adhesion | 95 | g/m² |
| Total thickness | 0.26 | mm |
| Adhesive strength on steel | 5.0 to 7.0 | N/cm |

Essential properties:
Temperature class D (LV 312)

### Example 2

Web Constructions

Textile carrier: Wet web (wet-laid)
Basis weight: 35 g/m²

Composition 100 wt. % PLA
5 parts per 100 of binder (with respect to 100 parts of PLA)

Pressure-sensitive adhesive:Acrylate adhesive

Essential property:
Temperature class C (LV 312)

1. An adhesive tape for wrapping elongated material, said adhesive tape comprising a carrier material that is provided on at least on one side with an adhesive coating,
wherein
the carrier material comprises at least one layer containing at least 75 wt. % of polylactic acid (PLA),
wherein the PLA contains a physical blend of at least two PLA polymers, PLA polymer A and PLA polymer B,
wherein PLA polymer A comprises at least 80% D,D-lactide and PLA polymer B comprises at least 80% L,L-lactide, and
wherein the ratio of D-lactic acid to L-lactic acid in the PLA blend is between 0.4:0.6 and 0.6:0.4.

2. The adhesive tape as claimed in claim 1,
wherein
the carrier material comprises at least 80 wt. % of polylactic acid (PLA) or the carrier material comprises 98 wt. % of polylactic acid (PLA).

3. The adhesive tape as claimed in claim 1,
wherein
PLA polymer A forming the PLA blend comprises at least 90% D-lactic acid, and/or PLA polymer B forming the PLA blend comprises at least 90% L lactic acid.

4. The adhesive tape as claimed in claim 1,
wherein
the ratio of D-lactic acid to L-lactic acid in the PLA blend is 0.45:0.55 to 0.55:0.45.

5. The adhesive tape as claimed in claim 1,
wherein
the carrier material comprises exactly one layer containing at least 75 wt. % of polylactic acid (PLA).

6. The adhesive tape as claimed in claim 1,
wherein
the carrier material is a textile carrier.

7. The adhesive tape as claimed in claim 1,
wherein
the width of the carrier material is 9 to 38 mm.

8. The adhesive tape as claimed in claim 1,
wherein
the carrier material has a basis weight of 30 to 250 g/m².

9. The adhesive tape as claimed in claim 1,
wherein
the adhesive coating is an adhesive compound based on natural rubber, synthetic rubber, acrylate, or silicone.

10. A method for wrapping elongated material, said method comprising wrapping the adhesive tape as claimed in claim 1 in a helix around the elongated material.

11. The method as claimed in claim 10, wherein the elongated material is wrapped with the adhesive tape in an axial direction.

12. An elongated material wrapped with an adhesive tape as claimed in claim 1.
